(19) United States
(12) Patent Application Publication
(10) Pub. No.: US 2026/0021590 A1
(43) Pub. Date: Jan. 22, 2026

(54) METHOD FOR SAFETY MONITORING, ROBOT, AND ROBOT SYSTEM

(71) Applicant: ABB SCHWEIZ AG, Baden (CH)

(72) Inventor: Jiafan Zhang, Shanghai (CN)

(21) Appl. No.: 19/346,816

(22) Filed: Oct. 1, 2025

Related U.S. Application Data
(63) Continuation of application No. PCT/CN2023/094218, filed on May 15, 2023.

(51) Int. Cl. B25J 13/08; B25J 9/16

(52) U.S. Cl. CPC B25J 13/089; B25J 9/1676

(57) ABSTRACT

Embodiments of present disclosure relate to a method safety monitoring. The method includes obtaining sensor data collected by at least one sensor on a transportation device associated and in communication with the robot. The method further includes detecting presence of a human based on the sensor data. The method further includes determining a relative position of the human with regard to the robot based on the sensor data. The method further includes determining a control operation based on the relative position.

### FIELD

Embodiments of the present disclosure generally relate to the field of robotics, and more particularly, to a method for safety monitoring, a robot, and a robot system.

### BACKGROUND

Nowadays, applications using free-accessible robot is increasingly demanded. In some examples, in an industrial facility where a plurality of working station are arranged in a decentralized manner, transportation devices such as automated guided vehicles (AGVs) or autonomous mobile robots (AMRs) may be provided to transfer materials to be processed from one working station to another working station. In such industrial facility, the working station where robots operate is usually not provided with fences to quarantine personnel on the field. In this case, safeguarding functionality is required. That is, when some personnel have gotten too close to the robot working area of an operating robot, the operating robot may need to reduce its operation speed, or even stop immediately.

In order to automatically take measures in response to the detection of personnel being too close to an operating robot, the robot needs to monitor its vicinity and determine whether there are personnel who enter specific areas around the robot.

### SUMMARY

In view of the foregoing description, example embodiments of the present disclosure propose solutions for safety monitoring to provide safeguarding functionality.

In a first aspect of the present disclosure, example embodiments of the present disclosure provide a method for safety monitoring. The method for safety monitoring comprises obtaining sensor data collected by at least one sensor on a transportation device associated and in communication with a robot. The method further comprises determining presence of a human based on the sensor data. The method further comprises determining a relative position of the human with regard to the robot based on the sensor data. The method further comprises determining a control operation based on the relative position. With these embodiments, by utilizing sensor data collected with sensors on the transportation device, no additional sensors are need for safeguarding functions thereby reducing the cost of the robot system.

In some example embodiments, the method further comprises receiving by the robot the sensor data from the transportation device and performing the control operation upon determination of the control operation by the robot. With these embodiments, the method for safety monitoring may be implemented at the robot. The robot may constantly receive sensor data from the transportation device and perform the determined control operation when the control operation is determined.

In some example embodiments, the method further comprises transmitting instructions to control the robot to perform the control operation by the transportation device to the robot. With these embodiments, the method for safety monitoring is implemented at the transportation device.

In some example embodiments, in determining the relative position, the robot or the transportation device may determine at least one human position of the human relative to the at least one sensor based on the sensor data. The robot or the transportation device may determine at least one sensor position of the at least one sensor. The robot or the transportation device may determine the relative position based on the at least one sensor position and the at least one human position. With these embodiments, by calculating relative positions of both of the human and the robot relative to the sensors, the relative position between the human and the robot can be obtained.

In some example embodiments, in determining the relative position based on the at least one sensor position and the at least one human position, the robot or the transportation device may determine at least one human vector between the at least one sensor and the human based on the at least one human position and the at least one sensor position. The robot or the transportation device may determine at least one sensor vector between the at least one sensor and the robot based on the at least one sensor positions and a robot position of the robot. The robot or the transportation device may determine at least one detection vector based on the at least one human vector and the at least one sensor vector. If it is determined that the at least one detection vector indicates a single distance between the human and the robot, the robot or the transportation device may determine one of at least one detection vector representing the relative position between the human and the robot.

In some alternative embodiments, if it is determined that the at least one relative position indicates a plurality of distances between the human and the robot, the robot or the transportation device may determine a relative position indicating a minimum distance of the plurality of distances representing the relative position between the human and the robot. With these embodiments, by selecting a relative position with a smaller distance, the safety level is increased.

In some example embodiments, in determining the control operation, the robot or the transportation device may determine a distance between the robot and the human based on the relative position. The robot or the transportation device may obtain at least one distance threshold associated with a working range of the robot. The robot or the transportation device may determine the control operation based on the distance and the at least one distance threshold. With these embodiments, by comparing the obtained distance with the at least one distance threshold, a suitable control operation can be determined from a plurality of control operations corresponding to different scenarios.

In some example embodiments, in determining the control operation based on the distance and the at least one distance threshold, if it is determined that the at least one distance threshold comprises a first distance threshold associated with a maximum working range of the robot, the robot or the transportation device may compare the first distance threshold and the distance. It is determined that the distance is smaller than the first distance threshold, the robot or the transportation device may determine the control operation as suspension of an operation of the robot. With these embodiments, the first distance threshold is greater than the maximum working range of the robot.

In some alternative embodiments, in determining the control operation based on the distance and the at least one distance threshold, if it is determined that the distance is greater than the first distance threshold, the robot or the transportation device may compare the distance and a second distance threshold greater than the first distance. If it is determined that the distance is smaller than the second distance threshold, the robot or the transportation device may determine the control operation as reduction of an operation speed of the robot.

In some alternative embodiments, in determining the control operation based on the distance and the at least one distance threshold, if it is determined that the distance is greater than the second distance threshold, the robot or the transportation device may determine the control operation as maintaining the operation of the robot. With these embodiments, by sequentially comparing the determined distance with all the distance threshold, the risk of a potential collision can be determined.

In some example embodiments, the transportation device comprises an automated guided vehicle (AGV) or an autonomous mobile robot (AMR).

In some example embodiments, the robot is integrated on the transportation device.

In some example embodiments, in some cases that the robot is separated from the transportation device, the transportation device may be communicated with the robot wirelessly. In some cases that the robot is integrated on the transportation device, the transportation device may be communicated with the robot wirelessly or through cables with dedicated interface. With these embodiments, the robots and the transportation device can be arranged in the industrial facility more flexibly.

In a second aspect, example embodiments of the present disclosure provide a robot. The robot comprises at least one controller; and at least one memory storing instructions that, when executed by the at least one controller, cause the robot to perform the method for safety monitor in accordance with the first aspects of the present disclosure.

In a third aspect, example embodiments of the present disclosure provide a robot system. The robot system comprises at least one robot configured to process materials and configured to perform the method according to the first aspect of the present disclosure. The robot system further comprises at least one transportation device. The at least one transportation device comprises at least one sensor configured to detect a human, and the at least one transportation device is configured to carry materials to the at least one robot.

In a fourth aspect, example embodiments of the present disclosure provide a computer readable medium having instructions stored thereon, the instructions, when executed on at least one processor, cause the at least one processor to perform the method safety monitor in accordance with the first or second aspects of the present disclosure.

### BRIEF DESCRIPTION OF THE DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an exemplary and in a non-limiting manner, wherein:

FIG. 1 schematically illustrates a block diagram of an example robot system in which example embodiments of the present disclosure can be implemented;

FIG. 2 schematically illustrates a signaling diagram of example procedures for safety monitoring in accordance with embodiments of the present disclosure;

FIGS. 3A-3C schematically illustrate flowcharts of a method for determining a control operation in accordance with embodiments of the present disclosure;

FIG. 4 schematically illustrates a schematic diagram of an example robot system in accordance with some embodiments of the present disclosure;

FIG. 5 schematically illustrates a schematic diagram of an example robot system in accordance with some further embodiments of the present disclosure;

FIG. 6 schematically illustrates a schematic diagram of an example robot system in accordance with yet further embodiments of the present disclosure; and

FIG. 7 schematically illustrates a schematic diagram of a controller for implementing a method in accordance with embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the know circle of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As described above, conventionally, in order to monitor moving objects, most of all humans, in proximity of the free-accessible robot, a dedicated laser sensor with wide sensing range needs to be provided for objects detection. However, such laser sensor is expensive thereby increasing the overall cost of the robot system.

In view of the above, a safety monitoring mechanism is provided. In the safety monitoring mechanism, a robot obtains and utilizes sensor data collected by a transportation device in association and communication with the robot obtains. During the process where the transportation device moves according to its predefined route and parks at the working station to perform collaborative operations with the robot operating in the working station, the transportation device utilizes its sensor to detect objects on its route to avoid collision. The detection range of the sensors on the transportation device may cover a very wide range, especially the working area of the robots. Therefore, the robot may utilize the sensor data to determine whether personnel are in the working area of the robot. In this way, the safeguarding function can be achieved without additional laser sensors thereby reducing the overall cost of the robot system.

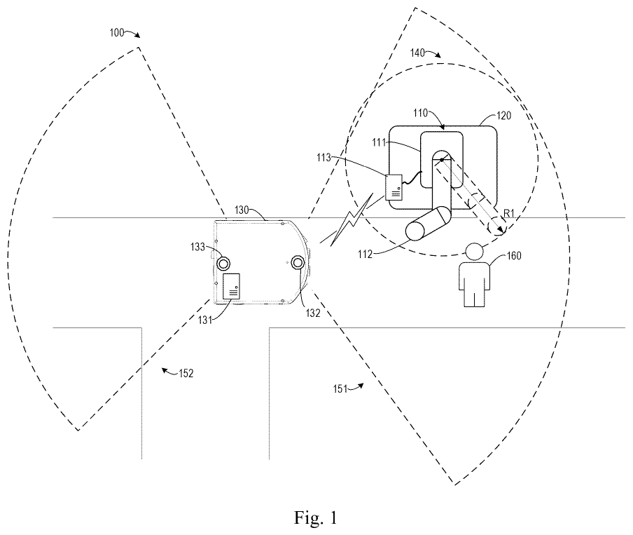

A framework in accordance with embodiments of the present disclosure will be described with reference to FIG. 1. FIG. 1 schematically illustrates a block diagram of an example robot system 100 in which example embodiments of the present disclosure can be implemented. As illustrated in FIG. 1, the robot system 100 includes a robot 110 deployed in a working station 120 for example in an industrial facility. In the industrial facility, there may be a plurality of working stations arranged on the side of aisles. The aisles are provided for transportation devices to travel to the associated robots. The working station 120 is fixed at a position in the industrial facility which is known to a controller 110 coupled to the robot 120. The controller 110 is configured to control operations of the robot 120.

As illustrated, the robot system 100 further includes a transportation device 130. The transportation device 130 is associated with the robot 110 and they are wirelessly connected and communicated with each other over a wireless network. For example, the robot 110 and the transportation device 130 may be all connected to wireless local area network (WLAN) of the industrial facility. The transportation device 130 comprises a controller 131 configured to control the transportation device 130 to travel along a preprogramed route. When the transportation device 130 reaches the working station 120, an arm 112 of the robot 110 may pick up materials carried by the transportation device 130 for further processing. After the collaborative operation is complete, the transportation device 130 will continue to travel along the route and may carry the remaining materials to the next working station.

The robot 110 includes a base 111 and an arm 112. The base 111 may be fixed at the working station 120. The arm 112 may for example be provided with an end effector at one end. The arm 112 may include a plurality of sections. Each section may be able to rotate around another section connected to it. In the illustrated embodiment, when all the sections of the arm 112 are aligned in a straight line, the arm 112 may reach an edge of its maximum working area 140 with a radius R1. If a human enters into the maximum working range 140, it may collide with the arm 112.

The transportation device 130 is configured to detect obstacles in the predefined route with laser scanners during movement to avoid collisions. In the illustrated embodiment, there are two laser scanners provided on the transportation device 130, including a first laser scanner 132 in the front and a second laser scanner 133 in the rear. The first laser scanner 132 may be configured to detect the objects in a front range 151 and the second laser scanner 133 may be configured to detect the objects in a rear range 152 such that they can cover a wide range around the transportation device 130. When the transportation device 130 detects a human, for example a human 160 as illustrated, in its predefined route, the transportation device 130 may determine a relative distance from the human 160 to check whether there is a risk that the human 160 would collide with the transportation device 130. If the transportation device 130 finds that there is indeed a risk, the transportation device 130 may decelerate or stop.

Further, since the transportation device 130 can communicate with the robot 110, sensor data about the presence of the human 160 may be transmitted from the transportation device 130 to the robot 110. In such a way, the robot 110 may also be aware of the presence of the human 160 and take corresponding measures to avoid collisions between the arm 112 and the human 160.

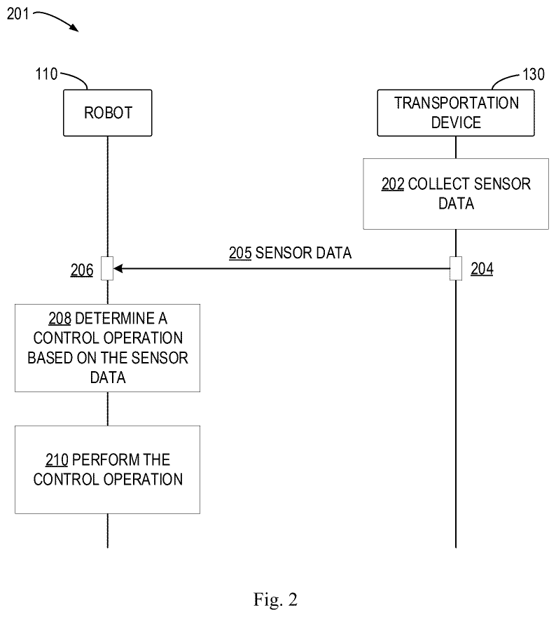

Hereinafter, the safety monitoring mechanism will be described in detail with reference to FIGS. 2-6. The safety monitoring mechanism is implemented by collaborative operations between a robot and a transportation device. In the mechanism, a control operation in response to the detection of a human in the range can be determined by the robot which is as illustrated in FIG. 2.

FIG. 2 schematically illustrates a signaling diagram of an example procedure 200 for safety monitoring in accordance with embodiments of the present disclosure. For discussion purpose, the procedure 200 will be described with reference to FIG. 1. The procedure 200 may be implemented between the robot 110 and the transportation device 130 in FIG. 1.

As illustrated in FIG. 2, at 202, the transportation device 130 collects sensor data for example with the first laser scanner 132 and the second laser scanner 132. At 204, after the sensor data is obtained, the transportation device 130 transmits the sensor data 205 to the robot 206. At 206, the robot 110 receives the sensor data 205. At 208, the robot 110 determines a control operation based on the received sensor data. For example, a human in the vicinity of the robot can be detected by utilizing at least one laser scanner already equipped on the transportation device. In some example embodiments, a human may be identified by a pattern derived from the sensor data. For example, if a width of an object detected by the sensor falls into a predefined width range for humans, the controller may determine that a human is detected. Alternatively, a speed of a detected object can be derived from sensor data collected at time intervals. In this case, when the derived speed falls into a predefined range for human speed, the controller may determine that a human is detected. It should be appreciated that a human can also be detected by other suitable techniques, for example with the aid of machine vision.

In the case of two laser scanners provided on both front side and rear side of the transportation, the distance between the human to the robot can be calculated by

$$D = min ( ‖ \vec{{O}_{S , F} P} + \vec{{O}_{R} {O}_{S , F}} ‖ , ‖ \vec{{O}_{S , R} P} + \vec{{O}_{R} {O}_{S , R}} ‖ ) \qquad ( 1 )$$

where O_{S,F} denotes a position of the first laser scanner on the front side, P denotes a position of the person, O_{R} denotes a position of the robot, O_{s,R} denotes a position of the second laser scanner on the rear side. Thus, \vec{O_{R}O_{S,F}} represents a vector from the robot to the first laser scanner, \vec{O_{S,F}P} represents a vector from first laser scanner to the person, and \vec{O_{R}O_{S,R}} represents a vector from the robot to the second laser scanner, \vec{O_{S,R}P}represents a vector from the second laser scanner to the person. In this case, the distance is a minimum of a first distance indicated by the vector derived from sensor data collected by the first laser scanner and a second distance indicated by the vector derived from sensor data collected by the second laser scanner.

After the distance between the human and the robot is determined, the robot 110 uses the determined distance to determine a control operation. For example, there are two predefined distance thresholds both greater than a maximum working range R1 of the robot 110, including a first distance threshold R2 and a second distance threshold R3. The control operation may be determined according to the following criterion. For example, if D>R₃, the robot can keep the full max operation speed. If R₃≥D>R₂, the robot needs to decrease the operation speed. If R₂≥D, the robot should stop immediately.

In this case, the control operations are operations to be performed by the robot 110 under control of the controller 111 in response to detecting a human in the vicinity of the robot 110. At 210, after a suitable control operation is determined, the robot 210 performs the control operation.

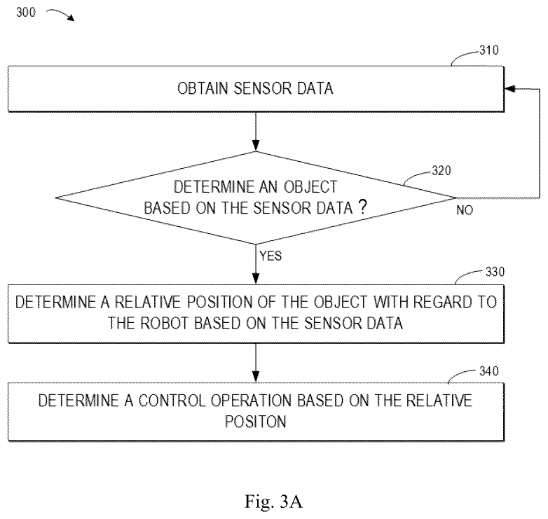

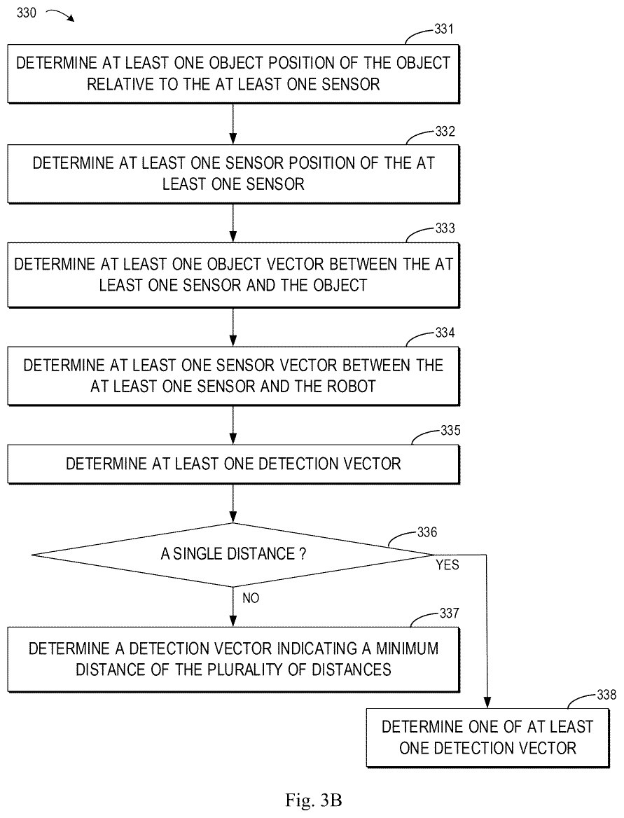

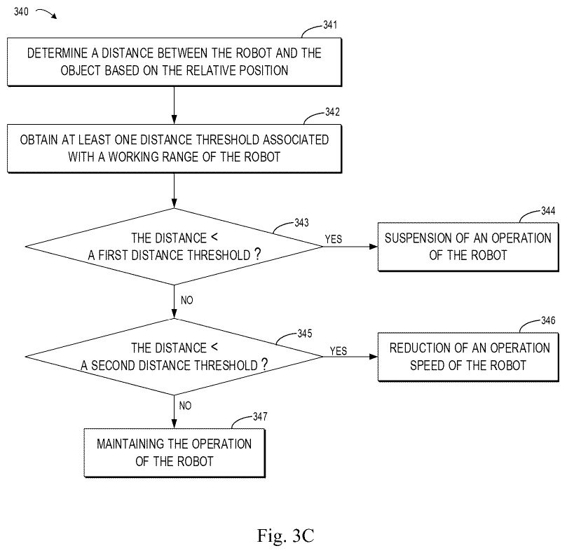

With both embodiments, by utilizing the sensor data collected by the laser sensors of the transportation device, the distance between the human and the robot can be derived and suitable control operations can be determined based on the derived distance. In this way, no additional sensors are required thereby reducing the cost of the robot. The method for determining a control operation will be described in detail with reference to FIGS. 3A-3C.

FIG. 3A schematically illustrates a flowchart of a method 300 for determining a control operation in accordance with embodiments of the present disclosure. The method 300 may be implemented by the controller 111 of the robot 110 in FIG. 1.

As illustrated in FIG. 3A, at 310, the controller 111 obtains sensor data. In case of the controller 111, the robot 110 may obtain the sensor data from the transportation device 130 via wireless communication. In this case, the sensor data is collected by at least one sensor provided on the transportation device 130 which is originally configured to detect obstacles along a predefined route of the transportation device 130 to avoid collision between the transportation device 130 and the obstacles.

At 320, the controller 111 determines a presence of a human based on the sensor data. If the controller 111 determines that there is no human detected, the method 300 will get back to 310 and obtains sensor data for example according to a predefined interval. In comparison, if the controller 111 determines that a human is detected, the method 300 will proceed to 330. At 330, the controller 111 determines a relative position of the human with regard to the robot based on the sensor data. Then, at 340, the controller 111 determines a control operation based on the relative position. Hereinafter, the method for determining a relative position and the method for determining a control operation will be described in detail with reference to FIGS. 3B and 3C.

FIG. 3B schematically illustrates a flowchart of a method 330 for determining a relative position of the human with regard to the robot in accordance with embodiments of the present disclosure. The method 330 may be corresponding to the step 330 as illustrated in FIG. 3A, and implemented by the robot 110 in FIG. 1 or the transportation device 130 in FIG. 1, especially the controller 111 of the robot 110 or the controller 131 of the transportation device 130.

As illustrated in FIG. 3B, at 331, the controller 111 determines at least one human position of the human relative to the least one sensor based on the sensor data. In some example embodiments, the transposition device may include a single sensor and the controller may determine a single human position between the sensor and the human. Alternatively, the transposition device may include a plurality of sensors and the controller may determine a plurality of human positions between the human and respective sensors of the plurality of sensors. In this case, each one of the detected human positions is collected by a respective one of the plurality of sensors.

At 332, the controller 111 determines at least one sensor position of the at least one sensor. In some example embodiments, the sensor position may be a global coordinate of the sensor in a coordinate system of the industrial facility. Alternatively, the sensor position may be a coordinate of the sensor with regard to any reference point in the facility.

At 333, the controller 111 determines at least one human vector between the at least one sensor and the human based on the at least one human position and the at least one sensor position. In some example embodiments, the at least one human vector may be derived from a coordinate of the human and at least one coordinate of the at least one sensor in the same coordinate system.

At 334, the controller 111 determines at least one sensor vector between the at least one sensor and the robot based on the at least one sensor positions and a robot position of the robot. In some example embodiments, the at least one sensor vector may be derived from at least one coordinate of the at least one sensor and a coordinate of the robot in the same coordinate system.

At 335, the controller 111 determines at least one detection vector based on the at least one human vector and the at least one sensor vector. In the case of a plurality of sensors, since the tolerance and operation condition of the sensors may differ from each other, the detection vector derived from different sensor data collected by different sensors may be different. At 336, after the detection vector is derived, the controller 111 determines the number of distances indicated by the at least one detection vector. If the controller 111 determines that the at least one detection vector indicates a plurality of distances, that is more than one distance, the method 330 proceeds to 337. At 337, the controller 111 determines a detection vector indicating the minimum distance of the plurality of distances to represent the relative position between the human (for example the human 160) and the robot 110.

If the controller 111 determines that the at least one detection vector indicates a single distance, the method 330 proceeds to 338. For example, the at last one detection vector includes only one detection vector. Alternatively, the at last one detection vector includes a plurality of detection vectors and the differences between distances indicated by the plurality of detection vectors lie in a predefined tolerance range. At 338, the controller 111 determines any one of the at least one detection vector to represent the relative position between the human and the robot 110.

With these embodiments, a relative position can be obtained among the at least one sensor in discretion thereby avoiding the influence of interference or poor operation condition.

FIG. 3C schematically illustrates a flowchart of a method 340 for determining a control operation based on the relative position in accordance with embodiments of the present disclosure. The method 340 may be corresponding to the step 340 as illustrated in FIG. 3A, and implemented by the robot 110 in FIG. 1 or the transportation device 130 in FIG. 1, especially the controller 111 of the robot 110 or the controller 131 of the transportation device 130.

As illustrated in FIG. 3C, at 341, the controller 111 determines a distance between the robot 110 and the human based on the relative position, in this case the distance between the robot 110 and the human 160. At 342, the controller 111 obtains at least one distance threshold associated with a working range of the robot 110. In some example embodiments, the at least one distance threshold may include two distance thresholds.

At 343, the controller 111 compares the distance with a first distance threshold of the at least one distance threshold. In this case, the first distance threshold may be associated with a maximum working range 140 of the robot 110 or a maximum length of an arm of the robot. In some example embodiments, the first distance threshold is equal to or greater than the maximum length of the arm of the robot.

If the controller 111 determines that the distance is smaller than the first distance threshold, the method will proceed to 344. At 344, the controller 111 determines a suspension of the current operation of the robot 110 as the control operation. In other words, if the controller 111 determines that the human 160 is getting close enough to the robot 110, for example enters into a first area defined by the first distance threshold, the controller 111 may stop the robot 110 and put the current operation sequence on hold. In some example embodiments, when the controller 111 determines that the human 160 walks out of the first area defined, the controller 111 may resume the on-hold operation.

If the controller 111 determines that the distance is no less than the first distance threshold, the method will proceed to 345. At 345, the controller 111 compares the distance with a second distance threshold. In this case, the second distance threshold is greater than the first distance threshold. In some example embodiments, the second distance threshold is selected such that when the human 160 enters into the area between the first distance threshold and the second distance threshold, the human 160 could not enters the working area of the robot at next detection time point. If the controller 111 determines that the distance is smaller than the second distance threshold, the method will proceed to 346. At 346, the controller 111 determines a reduction of an operation speed of the robot 110 as the control operation. If the controller 111 determines that the distance is no less than the second distance threshold, the method will proceed to 347. At 347, the controller 111 determines maintaining the current operation of the robot 110 as the control operation.

With these embodiments, a suitable control operation can be determined according to the comparison between a distance indicated by the relative position and a set of predefined distance thresholds.

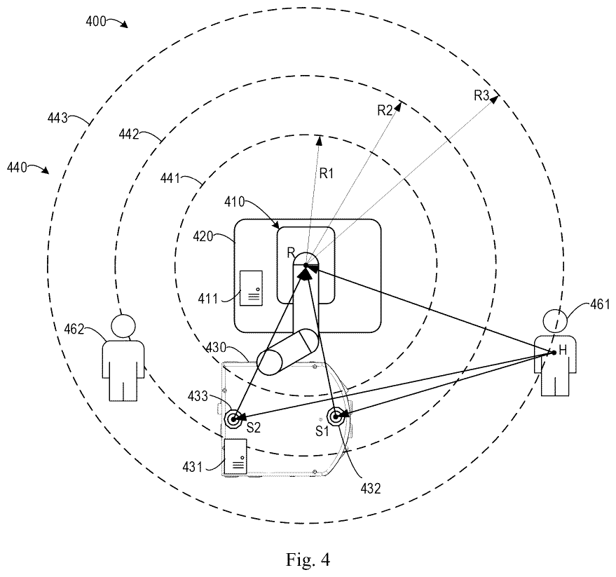

FIG. 4 schematically illustrates a schematic diagram of an example robot system 400 in accordance with some embodiments of the present disclosure. As illustrated in FIG. 4, the robot system 400 includes a robot 410 deployed in a working station 420. The robot 410 includes a controller 411 configured to control the operation of the robot 410. The robot system 400 further includes a transportation device 430 parking at a side of the robot 410. In the illustrated embodiments, the transportation device 430 is an automated guided vehicle (AGV). The AGV 430 includes a controller 431 configured to control the movement of the AGV 430 in the industrial facility. The AGV 430 further comprises a first laser sensor 432 and a second laser sensor 433. The detection ranges of the first laser sensor 432 and the second laser sensor 433 may both cover a wide range enclosing the working range of the robot 110. In this case, the controller 431 may operate with the first laser sensor 432 and the second laser sensor 433 to implement a simultaneous localization and mapping (SLAM) technology to determine the position of AGV 430.

A position of the robot 410 may be represented with a globe coordinate in a facility coordinate system and denoted as P_{R} (X_{R}, Y_{R}). The AGV 430 may travel along a predefined route automatically and is navigated according to its position in the industrial facility which is represented with a global coordinate P_{V} (X_{V}, Y_{V}) in the facility coordinate system.

In the illustrated embodiments, the AGV 430 is configured to carry materials to the working station 420. Therefore, the controller 431 knows the position P_{R} (X_{R}, Y_{R}) of the robot 410 and guides the AGV 430 to travel to the robot 410 according to their positions. Further, the AGV 430 constantly transmits sensor data collected by the first laser sensor 432 and the second laser sensor 433 to the robot 410. In this way, when the AGV 430 detects a human 461, the robot 110 may also identify the human 461 based on the sensor data received.

In some example embodiments, after the robot 410 receives the sensor data and identify the human 461 the controller 411 of the robot 410 may perform the method for determining a control operation as illustrated in FIGS. 3A-3C. After a control operation is determined, the controller 411 may cause the robot 410 to perform the determined control operation. Alternatively, when the AGV 430 detects the human 461, the controller 431 of the AGV 430 may perform the method for determining a control operation as illustrated in FIGS. 3A-3C. After a control operation is determined, the AGV 430 may transmit instructions to robot 410 to cause the robot 410 to perform the determined control operation.

Hereinafter, a procedure to determine a control operation will be described in detail. The controller 411 or 431 determines a first human position of the human 461 relative to the first laser sensor 432 and a second human position of the human 461 relative to the second laser sensor 433 from the received sensor data. In this case, the first human position maybe a coordinate in a coordinate system of the first laser sensor 432 and denoted as P_{HS1} (X_{HS1}, Y_{HS1}). Similarly, the second human position may be a coordinate in a coordination system of the second laser sensor 433 and denoted as P_{HS2} (X_{HS2}, Y_{HS2}). In order to determine the relative position between the human 461 and the robot 410, the controller 411 or 431 determines the first sensor position of the first laser sensor 432 and the second sensor position of the second laser sensor 433. For example, the first sensor position may a globe coordinate in the facility coordinate system and denoted as P_{S1} (X_{S1}, Y_{S1}) and its coordinate in the coordinate system of the first sensor may be denoted as P_{S1S1} (X_{S1S1}, Y_{S1S1}). The second sensor position may a globe coordinate in the facility coordinate system and denoted as P_{S2} (X_{S2}, Y_{S2}) and its coordinate in the coordinate system of the first sensor may be denoted as P_{S2S2} (X_{S2S2}, Y_{S2S2}).

Then, a first global coordinate P_{H1} (X_{H1}, Y_{H1}) of the human associated with the sensor data collected by the first sensor may be determined under the assumption that the first laser sensor is at the origin point of the coordinate system of the first laser sensor 432 by:

$${X}_{H 1} = {X}_{S 1} + {X}_{HS 1} - {X}_{S 1 S 1} \qquad ( 2 )$$

$${Y}_{H 1} = {Y}_{S 1} + {Y}_{HS 1} - {Y}_{S 1 S 1} \qquad ( 3 )$$

Similarly, a second global coordinate P_{H2} (X_{H2}, Y_{H2}) of the human associated with the sensor data collected by the second sensor may be determined under the assumption that the second laser sensor 433 is at the origin point of the coordinate system of the second laser sensor 433 by:

$${X}_{H 2} = {X}_{S 2} + {X}_{HS 2} - {X}_{S 2 S 2} \qquad ( 4 )$$

$${Y}_{H 2} = {Y}_{S 2} + {Y}_{HS 2} - {Y}_{S 2 S 2} \qquad ( 5 )$$

The controller 411 or 431 determines a first human vector V̅_{O1} from the human 461 to the first laser sensor 432 as follows:

$${\overline{V}}_{HS 1} = [ {X}_{H 1} - {X}_{S 1} , {Y}_{H 1} - {Y}_{S 1} ] \qquad ( 6 )$$

The second human vector V̅_{HS2} from the human 461 to the second laser sensor 433 and can be determined as follows:

$${\overline{V}}_{HS 2} = [ {X}_{H 2} - {X}_{S 2} , {Y}_{H 2} - {Y}_{S 2} ] \qquad ( 7 )$$

Then, the controller 411 or 431 determines a first sensor vector V̅_{S1R} from the first sensor 432 and the robot 410 as follows:

$${\overline{V}}_{S 1 R} = [ {X}_{S 1} - {X}_{R} , {Y}_{S 1} - {Y}_{R} ] . \qquad ( 8 )$$

Then, the controller 411 or 431 determines a second sensor vector V̅_{S2R} from the first sensor 432 and the robot 410 as follows:

$${\overline{V}}_{S 2 R} = [ {X}_{S 2} - {X}_{R} , {Y}_{S 2} - {Y}_{R} ] \qquad ( 9 )$$

Then, the controller 411 or 431 determines a first detection vector V̅_{HR1} from the human 461 to the robot 410 as follows:

$${\overline{V}}_{HR 1} = {\overline{V}}_{HS 1} + {\overline{V}}_{S 1 R} \qquad ( 10 )$$

Then, the controller 411 or 431 determines a second detection vector V̅_{HR2} from the human 461 to the robot 410 as follows:

$${\overline{V}}_{HR 2} = {\overline{V}}_{HS 2} + {\overline{V}}_{S 2 R} \qquad ( 11 )$$

In this way, the first detection vector V̅_{HR1} representing the relative position between the human 461 and the robot 410 and the second detection vector V̅_{HR2} also representing the relative position between the human 461 and the robot 410 are determined. Although both of the resultant vectors represent the same relative position, the two detection vectors are determined based on the sensor data collected by two different laser sensors. Therefore, there is a chance that the resultant detection vectors are different due to errors or tolerance caused by either sensor. In this case, a suitable relative position needs to be selected.

The controller 411 or 431 determines a first distance ∥V̅_{HR1}∥ of the first detection vector V̅_{HR1} and a second distance ∥V̅_{HR2}∥ of the second detection vector V̅_{HR2}. If the controller 411 or 431 compares the first distance ∥V̅_{HR1}∥ with the second distance ∥V̅_{HR2}∥. If the controller 411 or 431 determines that the first distance ∥V̅_{HR1}∥ is the same as the second distance ∥V̅_{HR2}∥, either one of them can be determined as a relative distance between the human 461 and the robot 410 and the corresponding detection vector will be determined to represent the. If the first distance ∥V̅_{HR1}∥ is smaller than the second distance ∥V̅_{HR2}∥, the corresponding first detection vector V̅_{HR1} will be selected to represent the relative distance in purpose of safety.

After the relative position between the human 461 and the robot 410 is determined, a control operation can be determined according to the method as illustrated in FIG. 3C. In this embodiment, a neighborhood area 440 around the robot 410 is divided into 4 areas. The first area is an area inside the circle 441 which corresponds to the maximum working area of the robot 410. In this case, a radius R1 of the circle 441 corresponds to the maximum extension of the robot arm. When a human gets into the first area, a collision with the robot may not be able to be avoided. Therefore, the operation of the robot must be stopped before the human gets too close to the robot. Thus, a first distance threshold R2 is selected to be greater than the radius R1 and a second area is illustrated as an area between a circle 442 with a radius equal to the first distance threshold R2 and the circle 441. When a human is determined to be inside the circle 442, the controller 411 will control the robot 410 to stop immediately. When the human is determined to have left the circle 442, the robot 410 may restore its operation. Outside the circle 442, there is a further circle 443. The radius of the circle 443 corresponds to a second distance threshold R3 greater than the first distance threshold. When a human is determined to be inside a third area between the circle 442 and the circle 443, the controller 411 will control the robot 410 to reduce the operation speed to a predefined range such that the robot 410 can stop timely if the human moves further towards the robot 410. In other cases, when a human is determined to be in a fourth area outside the circle 443, the robot 410 may restore its speed to normal operation speed.

As illustrated in FIG. 4, the controller 411 or 431 determines that the first distance ∥V̅_{HR1}∥ of the human 461 is greater than the second distance threshold R3. In this case, the human 461 is outside the circle R3 and the controller 411 or 431 determines that the control operation associated with the human 461 is to maintain the operation of the robot 110. In the meantime, the AGV 430 also detects a further human 462. By performing the same method, the controller 411 or 431 determines that the distance between the human 462 and the robot 110 is greater than the first distance threshold and smaller than the second distance threshold. The controller 411 or 431 determines a control operation associated with the human 462 is to reduce the operation speed of the robot 410.

In the scenario where there is more than one human that has been detected by the transportation device, the control operation may be determined based on the distance of the human closest to the robot.

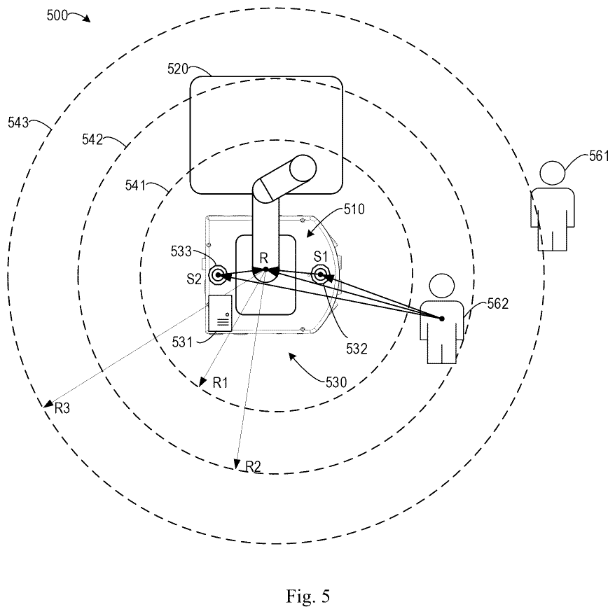

FIG. 5 schematically illustrates a schematic diagram of an example robot system 500 in accordance with some further embodiments of the present disclosure. As illustrated in FIG. 5, the robot system 500 includes a robot 510 deployed on a transportation device 530. In the illustrated embodiment, the transportation device 530 is an autonomous mobile robot (AMR). The robot 510 includes a controller 511 configured to control operations of the robot 510, and the AMR 530 includes a controller 531 configured to control the movement of the AMR 530 in the industrial facility. The AMR 530 may travel along a predefined route automatically and carry the robot 510 to a plurality of working stations arranged in the industrial facility. The AMR 530 is navigated according to its position in the industrial facility.

The AMR 530 further comprises a first laser sensor 532 and a second laser sensor 533. The detection ranges of the first laser sensor 532 and the second laser sensor 533 may both cover a wide range enclosing the working range of the robot 510. In this case, the controller 531 may operate with the first laser sensor 532 and the second laser sensor 533 to implement a simultaneous localization and mapping (SLAM) technology to determine the position of the AMR 530 as well as the position of the robot 510.

In the illustrated embodiment, the AMR 530 constantly collects sensor data with the first laser sensor 532 and the second laser sensor 533. In some example embodiments, the AMR 530 and the robot 510 may share the same controller. That is, the controller 511 and the controller 531 is one same controller which perform the control of both of the AMR 530 and the robot 510. In these embodiments, such a controller may determine a presence of a human based on the collected sensor data and may perform the method for determining a control operation as illustrated in FIGS. 3A-3C. After a control operation is determined, the controller may further cause the robot 510 to perform the determined control operation.

Hereinafter, a procedure to determine a control operation will be described in detail. The controller 511 or 531 determines a first human position of the human 561 relative to the first laser sensor 532 and a second human position of the human 561 relative to the second laser sensor 533 from the received sensor data. Since the AMR 530 carries the robot 510, a position of the robot 510 can be viewed the same as a position of the AMR 530. Therefore, for the sake of simplicity, the related positions may all be represented by coordinates in the coordinate system of the AMR 530. In this case, the first human position and the second human position maybe coordinates in the coordinate system of the AMR 530. In this way, a coordinate conversion from the coordinate system of the AMR 530 into a global coordinate system can be spared. A first human vector V̅_{HS1} from the human 562 to the first laser sensor 532 and a second human vector V̅_{HS2} from the human 562 to the second laser sensor 533 can be derived directly from the collected sensor data.

Since the robot 510 is fixed relative to the first laser sensor 532 and the second laser sensor 533, a first sensor vector V̅_{S1R} from the first sensor 432 to the robot 410 and a second sensor vector V̅_{S2R} from the first sensor 432 to the robot 410 can also be directly obtained.

Then, the controller 511 or 531 determines a first detection vector V̅_{HR1} from the human 562 to the robot 510 as follows:

$${\overline{V}}_{HR 1} = {\overline{V}}_{HS 1} + {\overline{V}}_{S 1 R} \qquad ( 12 )$$

Then, the controller 411 or 431 determines a second detection vector V̅_{HR2} from the human 562 to the robot 510 as follows:

$${\overline{V}}_{HR 2} = {\overline{V}}_{HS 2} + {\overline{V}}_{S 2 R} \qquad ( 13 )$$

In this way, the first detection vector V̅_{HR1} representing the relative position between the human 562 and the robot 510 and the second detection vector V̅_{HR2} also representing the relative position between the human 562 and the robot 510 are determined. Accordingly, since a first distance ∥V̅_{HR1}∥ of the first detection vector V̅_{HR1} is the same as a second distance ∥V̅_{HR2}∥ of the second detection vector V̅_{HR2}, the corresponding first detection vector V̅_{HR1} is selected to represent the relative distance.

In this embodiment, a neighborhood area 540 around the robot 510 is also divided into 4 areas, including a first area inside the circle 541 with a radius equal to the maximum length R1 of the arm of the robot 510, a second area between the circle 541 and a circle 542 with a radius R2, a third area between the circle 542 and a circle 543 with a radius of a second distance threshold R3 and a fourth area outside the circle 543.

As illustrated in FIG. 5, the controller 511 or 531 determines that the first distance ∥V̅_{HR1}∥ of the human 562 is smaller than the first distance threshold R2. That is, the human 562 is inside the circle 542. The controller 511 or 531 determines that the control operation associated with the human 562 is to stop the operation of the robot 110 immediately. Then, the controller 511 controls the robot 510 to stop.

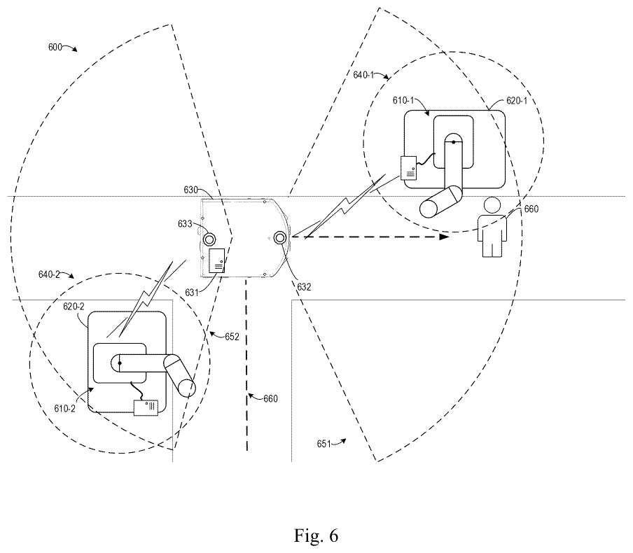

FIG. 6 schematically illustrates a schematic diagram of an example robot system 600 in accordance with yet further embodiments of the present disclosure. As illustrated in FIG. 6, the robot system 600 includes a robot 610-1 deployed at a working station 620-1 and a robot 610-2 deployed at a working station 620-2. The robot system 600 further includes a transportation device 630 configured to carry materials to be processed to the associated robots. The transportation device 630 includes a controller 631 configured to control the transportation device 630 to travel along a predefined route 660. As illustrated, the predefined route 660 is configured to sequentially pass by the working station 620-2 and the working station 620-1.

In operation, the transportation device 630 carries the materials to the working station 620-2 first, and parks on the side to allow the robot 610-2 to pick up its materials. After the operation at the working station 620-2 is complete, the transportation device 630 travels along the route 660 and carries the remaining materials to the working station 620-1 to allow the robot 610-1 to pick up its materials. For navigation, the transportation device 630 further comprises a first laser sensor 632 and a second laser sensor 633. A first detection range 651 of the first laser sensor 632 and a second detection range 652 of the second laser sensor 633 may both cover a wide range enclosing a neighborhood area 640-1 of the robot 610-1 and a neighborhood area 640-2 of the robot 610-2.

During the operation, the transportation device 630 is associated and in communication with the robot 610-1 and the robot 610-2. The transportation device 630 constantly transmits sensor data collected with the first laser sensor 632 and the second laser sensor 633 to the robot 610-1 and the robot 610-2 to allow the respective controllers of the robot 610-1 and the robot 610-2 to determine whether there is a human being too close to the respective robots according to the methods as illustrated in FIGS. 3A-3C. For example, the transportation device 630 may transmit sensor data about a human 660 to the robot 610-1 and the robot 610-2. The robot 610-1 may determine that the human 660 is in a third area as discussed with reference to FIGS. 4 and 5 and determine to reduce the operation speed. In comparison, the robot 610-2 may determine that the human 660 is in a fourth area as discussed with reference to FIGS. 4 and 5 and determine to maintain the current operation. In this way, more than one sensor may be spared so that the cost of the robot system can be further reduced.

It should be appreciated that a robot system may comprise any number of robots and any number of transportation able to implement the safety monitoring mechanism of the present disclosure.

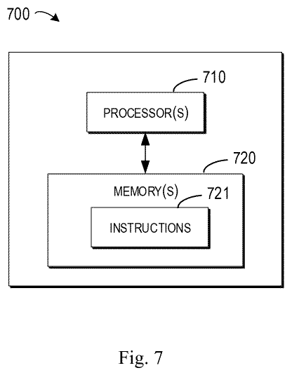

In some embodiments of the present disclosure, a computing device is provided for implementing the above methods 300, 330 and 340. FIG. 7 illustrates a schematic diagram of a controller 700 for implementing a method in accordance with embodiments of the present disclosure. The controller 700 may be corresponding to the controller 111 of the robot 110 in FIG. 1 or the controller 131 of the transportation device in FIG. 1. The controller 700 comprises: at least one processor 710 and at least one memory 720. The at least one processor 710 may be coupled to the at least one memory 720. The at least one memory 720 comprises instructions 722 that when executed by the at least one processor 710 implements the methods 300, 330 or 340.

In some embodiments of the present disclosure, a computer readable medium for adjusting robot path is provided. The computer readable medium has instructions stored thereon, and the instructions, when executed on at least one processor, may cause at least one processor to perform the method for managing a camera system as described in the preceding paragraphs, and details will be omitted hereinafter.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 3A-3C. Generally, program modules include routines, programs, libraries, objects, classes, components, data structures, or the like that perform particular tasks or implement particular abstract data types. The functionality of the program modules may be combined or split between program modules as ideal in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. On the other hand, various features that are described in the context of a single embodiment may also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It should be appreciated that the above detailed embodiments of the present disclosure are only to exemplify or explain principles of the present disclosure and not to limit the present disclosure. Therefore, any modifications, equivalent alternatives and improvement, etc. without departing from the spirit and scope of the present disclosure shall be included in the scope of protection of the present disclosure. Meanwhile, appended claims of the present disclosure aim to cover all the variations and modifications falling under the scope and boundary of the claims or equivalents of the scope and boundary.

It is to be understood that the summary section is not intended to identify key or essential features of embodiments of the present disclosure, nor is it intended to be used to limit the scope of the present disclosure. Other features of the present disclosure will become easily comprehensible through the following description.

1. A method for safety monitoring, comprising:
obtaining sensor data collected by at least one sensor on a transportation device associated with a robot;
detecting presence of a human based on the sensor data;
determining a relative position of the human with regard to the robot based on the sensor data; and
determining a control operation for the robot based on the relative position.

2. The method of claim 1, further comprising:
receiving, by the robot from the transportation device, the sensor data; and
performing, by the robot, the control operation upon determination of the control operation.

3. The method of claim 1, wherein determining the relative position comprises:
determining at least one human position of the human relative to the at least one sensor based on the sensor data;
determining at least one sensor position of the at least one sensor; and
determining the relative position based on the at least one sensor position and the at least one human position.

4. The method of claim 3, wherein determining the relative position based on the at least one sensor position and the at least one human position comprises:
determining at least one human vector between the at least one sensor and the human based on the at least one human position and the at least one sensor position;
determining at least one sensor vector between the at least one sensor and the robot based on the at least one sensor positions and a robot position of the robot;
determining at least one detection vector based on the at least one human vector and the at least one sensor vector; and
in response to determining that the at least one detection vector indicates a single distance between the human and the robot, determining one of at least one detection vector representing the relative position between the human and the robot.

5. The method of claim 4, wherein determining the relative position based on the at least one sensor position and the at least one human position further comprises:
in response to determining that the at least one relative position indicates a plurality of distances between the human and the robot, determining a relative position indicating a minimum distance of the plurality of distances representing the relative position between the human and the robot.

6. The method of claim 1, wherein determining the control operation comprises:
determining a distance between the robot and the human based on the relative position;
obtaining at least one distance threshold associated with a working range of the robot; and
determining the control operation based on the distance and the at least one distance threshold.

7. The method of claim 6, wherein determining the control operation based on the distance and the at least one distance threshold comprises:
in response to determining that the at least one distance threshold comprises a first distance threshold associated with a maximum working range of the robot, comparing the first distance threshold and the distance; and
in response to determining that the distance is smaller than the first distance threshold, determining the control operation as suspension of an operation of the robot.

8. The method of claim 7, wherein determining the control operation based on the distance and the at least one distance threshold further comprises:
in response to determining that the distance is greater than the first distance threshold, comparing the distance and a second distance threshold greater than the first distance;
in response to determining that the distance is smaller than the second distance threshold, determining the control operation as reduction of an operation speed of the robot.

9. The method of claim 8, wherein determining the control operation based on the distance and the at least one distance threshold further comprises:
in response to determining that the distance is greater than the second distance threshold, determining the control operation as maintaining the operation of the robot.

10. The method of claim 1, wherein the transportation device comprises an automated guided vehicle (AGV) or an autonomous transportation device (AMR).

11. The method of claim 10, wherein the transportation device is communicated with the robot wirelessly or through cables.

12. The method of claim 1, wherein the robot is integrated on the transportation device.

13. A robot comprising:
at least one controller; and
at least one memory storing instructions that, when executed by the at least one controller, cause the robot to perform the method of claim 1.

14. A robot system comprising:
at least one robot of claim 13 configured to process materials; and
at least one transportation device comprising at least one sensor configured to detect a human, and being configured to carry materials to the at least one robot.

15. A computer readable medium having instructions stored thereon, the instructions, when executed on at least one processor, cause the at least one processor to perform the method of claim 1.
